(19) United States
(12) Patent Application Publication
(10) Pub. No.: US 2026/0361241 A1
(43) Pub. Date: Nov. 12, 2026

(54) DEVICE AND METHOD TO PRODUCE ELECTRIC ENERGY FROM STAIRS

(71) Applicants: Jukka-Pekka TIUSANEN, Kangasala (FI); JPTUF OY, Kangasala (FI)

(72) Inventor: Jukka-Pekka TIUSANEN, Kangasala (FI)

(73) Assignee: JPTUF OY, Kangasala (FI)

(21) Appl. No.: 19/153,464

(22) PCT Filed: Feb. 6, 2024
(86) PCT No.: PCT/FI2024/050044

§ 371 Date: Aug. 4, 2025

(30) Foreign Application Priority Data
Feb. 7, 2023 (FI) 20235115

(51) Int. Cl. H02N 11/00; E04F 11/02; E04F 11/104; F03G 5/06

(52) U.S. Cl. CPC H02N 11/002; E04F 11/104; F03G 5/063; E04F 2011/0203; E04F 2011/1046

(57) ABSTRACT

A device to produce electric energy from stairs and it can be placed upon a staircase step and it consists in its operation state of the box that has two upon each other by joint joined parts and the limiter to limit the movement of the upper part. The device mounted machinery that has at least of one operation pair of gear racket fixed to the upper part of the box by the second joint and the first gearwheel fixed to the lower part of the box by the first axis which operation pair changes the movement of the mentioned gear rack into a rotation movement, and a connect organ with which the mentioned gear rack and gearwheel have been adapted to their highest position having been connected to be an operation pair, and a preloaded spring with the help of which the upper part of the box and the gear rack have been adapted to their highest position when the device is in the ready to operate state and to return there after pressing down by the load, and the gear that has been adapted to increase the rotation speed of the first gearwheel, and the generator that has been adapted to change with the mentioned operation pair and the gear achieved rotation movement into electric energy and which device can be connected to electric net.

The object of this invention is device and method to produce electric energy from stairs.

The intention of the invention is to take advantage of people moving in stairs by producing electric energy from it and this is based on weight of each person on the steps as he goes upwards or downwards the stairs.

The usages of the invention are mainly the places of heavy foot traffic, e.g. residential buildings, office buildings, schools, military buildings, the stairs in them, and also the out-door workout stairs. The invention can be used both in existing and new stairs under construction.

One advantageous usage possibility of the invention can be mentioned the devices according to the invention installed in the stairs of the military barracks. When the device installed advantageously in the stairs between two floors upon every step it is possible to achieve from a troop of one company climbing or descending one floor for generator rotors altogether even over 50′000 rounds. The application generators are relatively small in size but on the other hand there are a lot of them.

In the Ukrainian utility patent publication 106588 advantage is taken from the movement in stairs to produce electric energy in a linear generator using electric magnetic induction. The device of the publication is different from the device of the invention for instance in the generator type used and the arrangements used. In the solution of the publication they use a box to be put on the stairs the cover of which has been connected to the box air tight and set to lower in the horizontal position by the weight of the person stepping on it and to bounce back of the power of a spring. There has been located in the box a linear generator the rotors of which has been fixed to the lid and the stator in a box under it.

The greatest disadvantages of the before mentioned solutions according to the known technology are connected to the short movement that causes the electric magnetic induction and the shape of the box that makes the stairs essentially higher. The addition of the step forehead height is directly related to the length of the before mentioned movement.

The intention of this invention is to achieve such a device and method to produce electric energy from stairs that disadvantages of the known technology are avoided. It is characteristic for the solution according to the invention that has been presented in the characterizing parts of the claims 1 and 12.

A meaningful advantage of the invention when compared with the before mentioned solution according to the known technology is its adaptability to steps in stairs so that it does not add the height of the forehead of the step essentially because the amount of the movement to cause the electric magnetic induction is not directly related to the change of the height of the step and thus it is not more difficult to use the stairs for this reason. Another important advantage is obtained when the devices according to the invention use ordinary rotating generators and simple parts like gear racks and gearwheels. The efficiency of the electric magnetic induction that takes place in the generators can be increased by multiplying the length of the movement transferred by the person's foot to the device using a simple gear before it is transferred to the generator as a movement to generate electric magnetic induction.

The invention will be described in more detail in the enclosed figures where

FIG. 1 shows the device according to the invention in its usage position directly from the front,

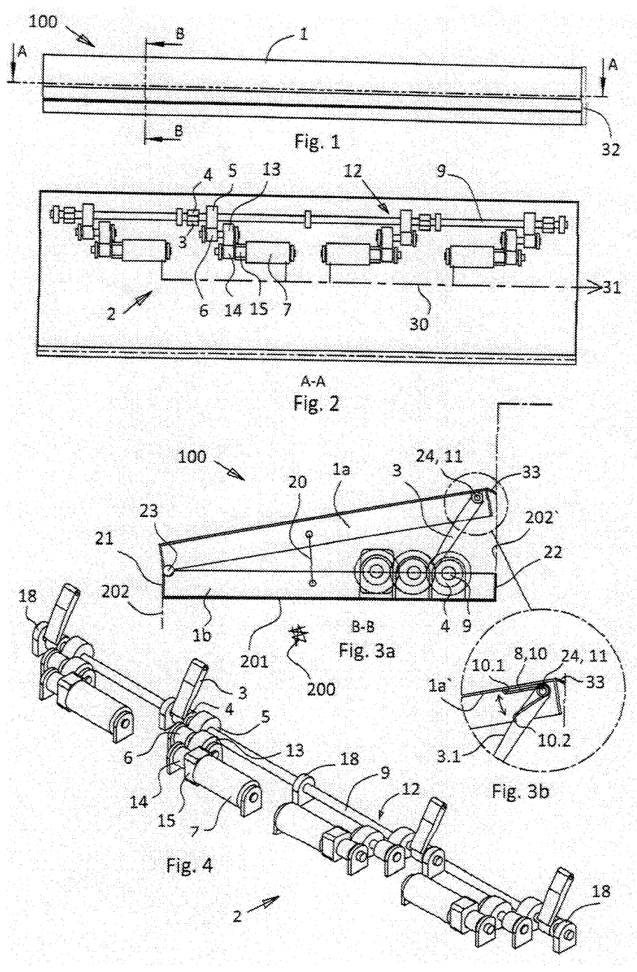

FIG. 2 shows the horizontal cut A-A of the FIG. 1,

FIG. 3a shows the vertical cut B-B of the FIG. 1,

FIG. 3b is a spot figure of the previous cut figure,

FIG. 4 shows in 3D the machinery belonging to the invention,

FIGS. 5a-5d describe the operation phases of the invention,

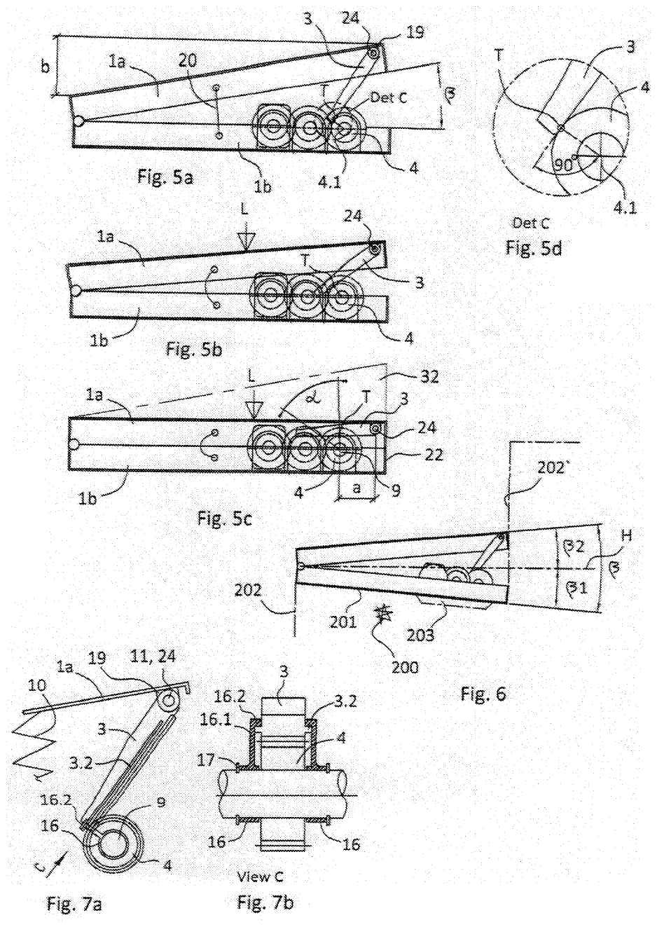

FIG. 6 shows one other invention application form,

FIGS. 7a-7b describe a third invention application form.

We explain in the following parts the structure of one favorable application of the invention and its operation referring to the previous figures.

In the FIG. 1 there has been shown the box 1 of the device 100 according to the invention directly from the front and in the FIG. 2 a horizontal cut in position A-A of the FIG. 1 and thus also the machinery 2 inside the box is visible. In the FIG. 3a there is a vertical cut in the position B-B of the FIG. 1 and it shows that the box is of two parts. In this figure, there has also been scheduled the stair step 200 and the device 100 has been placed upon it in a using position so that the lower surface of the lower part 1b is against the upper surface 201 of the step, the first side 21 is essentially in the line of the mentioned stair step forehead 202 and the second side 22 against the next higher step forehead 202′. The box upper part 1a is in a diagonal position, off the down part 1b in three sides.

The FIG. 4 shows in 3D the machinery 2 belonging to the device 100 and the FIGS. 5a-5d illustrate the different operation phases of the device: In the FIG. 5a the device is ready for the operation, in the FIG. 5b the weight of a person's foot or some other load L presses the upper part 1a of the box and a gear rack 3 fixed to it downwards and in the FIG. 5c the upper part is pressed against the down part 1b and is thus in the lowest possible position. In the FIG. 5d there is the position C of the FIG. 5a zoomed.

So the device 100 consists of the box 1 where there are two parts upon each other when it is in the operation position, the upper part 1a and the lower part 1b that have been connected to each other by the first joint 23 that has been fixed to the first side 21 of the mentioned box and thus the upper part 1a can be turned around the mentioned joint from the lowest possible position upwards loose the down part 1b into the position shown in the FIG. 3a. The limiter 20 limits the movement of the upper part here in its highest possible position. There has been mounted the machinery 2 inside the box 1 that consists of at least one in the upper part 1a of the box fixed operation pair that consists of by the other joint 24 to the upper part 1a of the box fixed gear rack 3 and to the box lower part by the first axis 9 fixed first gearwheel 4, connect organ 8, gear 12, and the generator 7. The mentioned contact organ is in this invention application a preloaded spring with which the mentioned gear rack and the gearwheel have been connected to be an operation pair and that operates also as a spring 10 that forces the upper part 1a of the box and the gear rack 3 into their upper position as the device is in a rest state and to return there after been pressed down by the load as the load releases. The preloaded spring 10 that has been shown in the FIG. 3b is in this solution a spiral spring that tends to expand that has been adapted around the second axis that is a part of the second joint 24 so that its first end's continuation part 10.1 rests against the inner surface 1a′ of the upper part 1a mantle and the continuation part 10.2 of the second end rests against the inner surface 3.1 of the gear rack. The preload of the spring keeps the setting as shown in the FIG. 3a and 5a so long that the load L is directed to the upper part 1a. In this case as the load is sufficient the upper part and the gear rack 3 that has been fixed to it get pressed downwards. In the FIGS. 5a-5d it has been illustrated the operation of the diagonally upright installed gear rack 3 before the load L and during its effect.

It is advantageous to include to the device 100 according to the invention also a gear 12 on the first gearwheel 4 of the gear rack 3 to increase the rotation speed, The gear intake is connected in this case on the first gearwheel 4. In the present invention application the gear 12 is a gearwheel group containing the second, the third, the fourth, and the fifth gearwheel 5, 6, 13, 14. The gear outtake is connected on the generator 7 axis. It is possible to include into the machinery also a rotation direction changer 15 that is used to change the rotation direction at the gear outtake if the generator rotator is desired to rotate to the same direction the whole duration of the back and forth movement of the gear rack. In this case the outtake of the gear is connected on the rotation direction changer 15 and the movement is transferred to the generator 7 rotor.

The second joint 24 that connects the gear rack to the upper part 1a has been adapted to be a favorable distance (a) closer to the other side 22 than the middle axis 4.1 of the first gearwheel. In other words, the second joint 24 and the middle axis 4.1 of the first gearwheel 4 have been adapted a distance (a) in different distance from the first joint 23 so that the dividing line/division curve of the gear rack 3 is the meeting point T of the mentioned gearwheel division diameter have been adapted to move at the circle of the mentioned gearwheel closer the distance of the angle α of the mentioned second side as the upper part 1a of the box presses into the down position and due to this the gear rack 3 is adapted to turn closer to the horizontal position and to fit inside the box 1 also when the box is wholly closed. The joints 23 and 24 and the first axis 9 are adapted in this invention application to be favorably functional of the same direction.

Differently from what has been presented before the gear rack 3 can be adapted also to the first side 21 the side of the first gearwheel 4 and then the measure (a) sets on the same side and the other organs of the machinery 2 are adapted taking this into account.

The FIG. 6 shows one application form of the invention that is suitable especially into the new stairs because the use of the invention can be taken into account already when planning the stairs. When the surface 201 of the stair step is made from the horizontal position in the angle β1 sloping so that it descends towards the next step the sloping of the box 2 upper part in relation to the horizontal position is obtained correspondingly smaller. One favorable way to realize this invention application form is to make the angle β1 same size with the horizontal position H and the angle between the upper part surface β2 so the opening angle of the totally opened box 2 opening angle β can be halved in relation to the horizontal level H. This application of the invention is especially well suitable for stairs that are used by young and old people.

The FIGS. 7a and 7b show a way to connect the gear rack 3 and the first gearwheel 4 as an operation pair that has not been shown before. There has been formed to the sides of the gear rack lengthy oriels 3.2 and on the first axis on the both sides of the gearwheel 4 there have been adapted ring like organs 16 using a slide fit and shafts to them and at the ends of the shafts 16.1 there are parts 16.2 that turn upon the oriels 3.2. These parts operate as a slide when the gear rack moves in relation to the gearwheel 4, turn in the first axis 9 when the gear rack turns and keep the gear rack and the first gearwheel connected to each other. The ring like organs 16 have been locked in the axis direction to their places using lock rings 17. In this solution, a separate spring 10 is needed to lift the upper part of the box back up.

The FIGS. 2 and 4 show that in the present application of the invention there are four power transfer energy production lines and each of them consists of at least a gear rack 3, the first gearwheel 4, the gear 12, and the generator 7. These lines can be situated into the device 100 a suitable amount in every situation.

The first axis 9 has been adapted to reach up to the whole width of the machinery 2 in this invention usage example and all the first and the second gearwheels 4, 5 have been adapted on this axis. Their movement into the direction of the axis has been prevented using some method of the known technology like for instance lock rings and the second gearwheel has been connected to rotate with the same rotation speed as the first gearwheel. One way to realize these features is to install the mentioned gearwheels on the axis 9 using the press-on fit and to allow the rotation of the axis and then the axis 9 can be fixed to the down part 1b of the box at a certain favorable height from its bottom using holed slide-fit hangers 18 and additionally the lengthwise movement of the axis will be prevented by for instance lock rings alongside the hangers. The first axis 9 can be made also in more than one part.

The second axis 11 that has been mounted to the upper part of the box operates as a part of the joints of the gear rack 3 so that the gear racks have been inserted into the holes in them and there is a slide fit between the axes and the holes. The axis 11 has been fixed to the inner surface 1a of the upper part of the box using holed hangers 19 and supported to their places in the axial direction. Likewise, the sideways movement of the gear racks 3 on the axis 11 is prevented.

The gear 12 has been realized in this example case with two different size gearwheels that have been located in a certain way on three axes side by side. The gearwheels have been connected to the power transfer line to increase the rotation speed as the rotation movement advances through them. This feature is advantageous for the use of the invention because one back and forth movement of the gear rack can be made to produce not more than a few first gearwheel 4 rotations.

The device 100 according to the invention that is connected to existing stairs to be able to be used without hindrance and safely it is favorable of the operation point of view that the machinery 2 fits in all the device operation phases inside the box 1 and it is the starting point in most of the presented invention applications. Another from the point of view of the invention central thing is to adapt when planning the device 100 to a certain place the rolling resistances of the gear 12 and the by the operation of the generator 7 caused rotor rotation resistance into a correct relation with the load L. Too big sum of the resistances in relation to the load slows down too much or even prevents the operation of the device and too small sum of the resistances in relation to the load means a device operation with below capacity. Because certain stairs going people are always of different weight it is favorable to make compromise solutions between the total resistance and the desired efficiency.

When the box 1 is made sufficiently stiff of the construction we get its upper part 1a to compress of the total width of the step at the same time even though the person's foot is stepping at its side area. The lower part 1b of the box can be fixed to the stair step using any known method.

The devices 100 according to the invention that have been installed to one or more staircases can be connected to same electric net 30 and the electric energy that has been produced to this net can be stored in a battery or a set of batteries 31 or it can be taken directly in use.

The following is an example of the measures of a device according to the invention:

The device 100 shown in the FIGS. 1-5d example application is suitable for a staircase step with the height of 180 mm, the depth 300 mm, and the width 1000 mm. The outside measures of the device 100 are 60×300×1000 mm. When the load L is not affecting the device its upper parts 1a sloping b is in during the distance of 300 mm 54 mm, that is the opening angle β is about 10°. When the load L presses the upper part 1a against the lower part 1b and as the load releases and the upper part returns to its starting position one to and fro movement of the gear rack 3 that is transferred to the division circle of the gearwheel 4 the division diameter of which is 20 mm the movement length is about 80 mm. The other gearwheel 5 that rotates to-gether with the mentioned gearwheel has a division diameter of 50 mm and it transfers a 2.5 times longer movement than the initial movement to the third gearwheel 6 the division diameter of which is 20 mm. The fourth gearwheel 13 on the same axis rotating at the same time and has a division diameter of 50 mm and thus the fifth gearwheel 14 connected to it having a division diameter of 20 mm receives 6.25 times the rotations in comparison to the rotation of the first gearwheel 4. This rotation movement is transferred to the generator 7 rotator and with this gear ratio it takes about 8 rounds during one box upper part 1a to and fro movement so that one person one floor (about 15 steps) climbing causes into one generator with the presented values total 120 rounds. When a company (100 persons) climes one floor we get 12000 rounds for one generator and as the device has four generators the total number of rounds is 48000. If the diameter of the generator stator limit surface is 35 mm the movement between them in the mentioned limit surface is about 5275 m. If the effective length of the rotor and the stator is 120 mm the corresponding “induction surface” is about 633 m². The generators are in this application of the invention in spite of their small size efficient producers of the electric energy.

The device 100 can be realized by measurements in many different ways. It is favorable for its use that the box 1 is low so that it would not hinder in getting to the first step and that its machinery 2 is able to operate appropriately in normal using of the stairs.

The box 1 can be made of for instance a metal sheet and its stiffness can be added by placing inside the box stiffeners. The stiffeners can be for instance to the sheet pressed or welded oriels. The box upper part 1a and the lower part 1b can be made for instance in a sheet treatment unit so that into their joint surfaces between them the horizontal parts are folded to help to get a sturdy contact between them.

The machinery 2 can be made in any for the situation suitable way. The power transfer and the energy production lines (at least gear rack 3, first gearwheel 4, gear 12, and generator 7) can be located there always a desired amount.

The gear line of the gear rack 3 can be made straight or curved. Even though it is in many situations favorable for the use of the invention that the machinery 2 fits to operate inside the box it can in for instance in new stairs be adapted so that for its operation parts like gear rack 3, gear 12, and generator 7 a space 203 is arranged underneath the lower part 1b of the box. In this case an opening is made to the low surface of the box for the of the diameter greater gearwheels and generators. This solution can add the electricity production efficiency.

The gearwheels 4, 5, 13, 14 can be made of the shape of cylinder or cone, straight gear or helical gear.

The toothing of the gear rack 3 and the first gearwheel 4 can in some cases made uneven friction surfaces when you get them sufficiently good contact with each other using a connection organ 8.

The operation of the connection organ 8 can be realized in also some other useful way than before stated. It is central for it that it is capable of holding the gear rack 3 and the first gearwheel 4 as an operation pair when the device 100 is operating.

The first axis 9, the second axis 11, and the other axes that have not been named in the examples of the invention, their hangers and other hangers, supports and limiters can be made using any known technology so that the parts they hang and support operate appropriately.

The spring 10 is favorable to be preloaded when the device 100 is in a stand-by situation so that the return of the upper part 1a to the top position would be quick and efficient enough after the load releases from the point of view of the operation of the device. The spring can be realized in many different ways. It can be issued two different tasks according to the previous example (FIGS. 3a, 3b) or it can be issued to only return the upper part 1a after the load ceases to have effect (FIG. 7a).

The limiter 20 can be made in numerous different ways. Its duty is to define the upper position of the upper part 1a and it must allow the upper part to move to the lower position.

The joints 23, 24 used in the device 100 according to the invention are based in the presented examples on the cooperation of the axes and to them mounted holed supports but they can be made also in any other usable way.

In the stairs where the steps are limited in one or both ends to a wall the corresponding end of the device 100 or both ends can be equipped with a vertical sheet 32 (FIGS. 1 and 5c) that is attached to the down part 1b and that covers the ready to use device end that resembles a cutter.

The upper part 1a of the cutter there can be put an elastic flap 33 (FIG. 3a) that closes the gap between the mentioned upper part and the step forehead surface when the upper part is in it upper position and moving by the effect of the load L and the spring 10. It is favorable that the flap can yield to the movement direction.

It should be noted that even though this explanation sticks to only one type of for the invention favorable realization example this does not in any way want to limit the usage of the invention for only this type of use but instead many variations are possible in the scope defined in the invention idea of the claims.

1. Device to produce electric energy from stairs which device can be adapted upon the stair step against its upper surface and consists of in its operation position:
a. box that has:
i. two parts upon each other that have been combined to each other by the first joint fit to the first side of the mentioned box so that the upper part of the box can be turned in relation to the mentioned joint loose the lower part,
ii. limiter that has been adapted to limit the movement of the upper part to a certain high position,
b. machinery mounted inside the box that consists at least of one equipment entity consisting at least of following organs:
i. the operation pair of the gear rack fixed to the upper part (1a) of the box by the second joint and the first gearwheel fixed to the lower part of the box by the first axis which operation pair transfers the movement of the mentioned gear rack into a rotation movement and the connection organ that combines the mentioned gear rack and the gearwheel into an operation pair,
ii. preloaded spring with the help of which the upper part of the box and the gear rack have been adapted to their upper position when the device is in ready to use state and to return there after the load has caused the pressing down,
iii. gear that has been adapted to increase the rotation speed of the first gearwheel,
iv. generator that has been adapted to change the rotation movement caused by the mentioned operation pair and gear into electric energy,
and which device can be connected into an electric net,
wherein the second joint and the first gearwheel center axis have been adapted the measure differing distance measured from the first joint, so that when pressing the upper part into its lowest position the meeting point of the gear rack and the first gearwheel has been adapted to move on the circle of the mentioned gearwheel the amount of the angle and the gear rack has thus been adapted to turn the same amount and as the upper part is in the lower position it is essentially in a horizontal position, and that the connection organ is the spring, or it is the device that is supported onto the first axis by the ring like organ and onto the gear rack by a slip structure adapted to glide in relation to it, thus preventing the formation of harmful compressive stress between the gear rack and the first gearwheel.

2. The device according to the claim 1 wherein the machinery contains a rotation direction changer to change the rotation direction to be fed to the generator.

3. The device according to the claim 1 wherein the machinery is mounted wholly inside the box.

4. The device according to claim 1 wherein the intake of the gear has been connected to the first gearwheel and the outtake to the axis of the rotation direction changer and the generator.

5. The device according to claim 1 wherein the second joint connecting to the upper part of the gear rack has been located such a favorable distance closer the second or the first side than the first gearwheel center axis that meeting point of the gear rack and the first gearwheel has been adapted to move on the mentioned gearwheel circle the distance corresponding the angle as the upper part presses downwards and caused by this the gear rack has been adapted to turn closer to the horizontal position and to fit inside the box as it closes.

6. The device according to claim 1 wherein the connect organ is a preloaded spring that has been adapted to return the upper part into its upper position as the load ceases to effect it.

7. The device according to claim 1 wherein the connect organ and the preloaded spring are different organs.

8. The device according to claim 1 wherein the box is of the shape essentially a rectangular when the upper part is pressed down against the lower part.

9. The device according to claim 1 wherein the gear increases the rotation speed fed to it at least six fold.

10. The device according to claim 1 wherein at least one of the ends of the device has been equipped with a vertical sheet that is fixed to the lower part and that covers the open, like a cutter end of the ready to use device out of the sight.

11. The device according to claim 1 wherein an elastic flap has been adapted to the upper part that closes the gap between the mentioned upper part and the step forehead when the upper part in the upper position and when moving under the effect of the load or the spring.

12. The method to produce electric energy from stairs wherein at least one device in claim 1 defined device is used in the following way:
a. The down surface of the lower part of the mentioned device is placed against the surface of the stair step and the second side against the forehead surface of the next higher step,
b. the upper part of the mentioned device and as the operation pair of the first gearwheel functioning gear rack are adapted to their upper position defined by the limiter with the help of the preloaded spring where the mentioned upper part is into the following higher step direction opening opening angle amount slope position in relation to the lower part,
c. the upper part is pressed by the load of a person's foot against the lower part or closer it and then the movement of the turning gear rack in relation to the second joint is transferred to the first gearwheel,
d. the movement that is transferred to the first gearwheel is led to the gear where its rotation speed is increased according to the gear ratio,
e. the rotation movement with the increased speed is led by the rotation direction changer or directly to the generator to produce electric energy.

13. The method according to claim 12 wherein the produced electric power is stored into a battery or set of batteries via an electric net.

14. The method according to claim 12 wherein it is used in residential buildings, office buildings, schools, and/or in stairs in military installations and/or outdoor workout stairs.
